(19) United States
(12) Patent Application Publication
(10) Pub. No.: US 2009/0318648 A1
(43) Pub. Date: Dec. 24, 2009

(54) MEDIA-RESISTANT COATING RESINS

(75) Inventors: Marianne Omeis, Dorsten (DE); Stefan Schrage, Muenster (DE); Martina Ebert, Dieburg (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Roehm GmbH, Darmstadt (DE)

(21) Appl. No.: 12/374,487

(22) PCT Filed: May 7, 2007
(86) PCT No.: PCT/EP07/54392

§ 371 Date: Jan. 21, 2009

(30) Foreign Application Priority Data
Aug. 18, 2006 (DE) 102006038714.7

(51) Int. Cl. C08F 4/72

(52) U.S. Cl. 526/192; 526/220

(57) ABSTRACT

The invention relates to compositions comprising glycerol mono(meth)acrylate and hydroxyethyl methacrylate, including those with addition of further monomers, free-radically polymerized and subsequently crosslinked with isocyanates, to a process for preparing them and to their use as film-forming resins with particular media resistance.

The invention relates to compositions comprising glycerol mono(meth)acrylate and hydroxyethyl (meth)-acrylate, which are polymerized and subsequently crosslinked with isocyanates, to a process for preparing them and to their use as film-forming resins featuring particular media resistance.

Glycerol mono(meth)acrylate is a much-used functional comonomer in adhesives, coating materials and optical materials. There are a variety of preparation processes known for glycerol mono(meth)acrylate.

Glycerol mono(meth)acrylate can be prepared by transesterifying methyl(meth)acrylate or by esterifying (meth)acrylic acid with glycerol. The product is a mixture of mono-, di- and trifunctionalized alcohol, which on account of the high water-solubility of the products can be separated only at great cost and inconvenience.

The synthesis pathway via a protected alcohol, the ketalized glycerol or the related glycidol, or the corresponding (meth)acrylate, is selected in order to obtain the monoester.

The coating of materials for the purpose of enhancing the surfaces and modifying the properties is a broad field of endeavour.

DE 2104730 claims perfluoroalkylmonocarboxylic esters starting from glycidyl methacrylate which are used as homopolymers or copolymers for treatment, preferably for generating oleophobic finishes on porous or non-porous substrates. In particular, on cotton, it is possible to achieve a soil release and antisoiling effect.

DE 19739640 describes curable coatings comprising aromatic tricarboxylic or tetracarboxylic acids and dihydroxyalkyl(meth)acrylates. These coatings are cured by means of radiation or heat and have good mechanical and optical properties. In particular there is an improvement in the adhesion to surfaces of plastics.

WO 2000/23521 claims unsaturated polyester resins of reduced monomer content which are used in gelcoats, coatings or laminates. These materials are said to be processable with conventional equipment and to have mechanical strength.

It was an object of the invention to prepare compositions based on glycerol mono(meth)acrylate which exhibit a particular media resistance.

This object has been achieved through compositions comprising glycerol mono(meth)acrylate and hydroxyethyl methacrylate, which are free-radically polymerized and subsequently crosslinked with isocyanates.

For the free-radical polymerization it is also possible to use further comonomers.

The notation “(meth)acrylate” here denotes not only methacrylate, such as methyl methacrylate, ethyl methacrylate, etc., for example, but also acrylate, such as methyl acrylate, ethyl acrylate, etc., for example, and also mixtures of both.

Surprisingly it has been found that the compositions of the invention feature film-forming resins possessing outstanding media resistance.

For coating applications the media resistance investigated is in particular the resistance to brake fluid, diesel, 2-propanol and methyl ethyl ketone. In this case, with the composition of the invention, outstanding resistances to these media have been found.

It was found that the best media resistance is achieved if glycerol mono(meth)acrylate and hydroxyethyl methacrylate are polymerized in a 1:1 molar ratio.

The invention also provides a process for preparing the composition of the invention. The process is characterized in that glycerol mono(meth)acrylate and hydroxyethyl methacrylate are polymerized in a suitable solvent at a temperature of 100-150° C. and with addition of initiators and are subsequently crosslinked with isocyanates.

Isocyanates used are preferably difunctional and polyfunctional aliphatic and also aromatic representatives. One typical representative of aliphatic isocyanate is the trimer of hexamethylene diisocyanate (trade name Desmodur N3300, Bayer AG).

It is preferred to use organotin compounds for catalysis and to set an NCO/OH ratio preferably of 42/58. The basis employed for calculation is the OH number of the resin.

It is also advantageous in the context of the process of the invention for the viscosities of the resulting film-forming resins to be below 20 000 mPas at 23° C., so that there are no restrictions whatsoever likely as a result of this when the clearcoat materials are subsequently formulated.

The compositions of the invention, comprising glycerol mono(meth)acrylate and hydroxyethyl methacrylate, which are polymerized with one another and subsequently crosslinked with isocyanates, find application in coating formulations.

The examples given below are given for the purpose of improved illustration of the present invention, but are not such as to restrict the invention to the features disclosed therein.

### EXAMPLES

### Example 1

A 1-litre flask with reflux condenser is charged with 100.02 g of n-butyl acetate and this initial charge is heated. The polymerization is carried out under a nitrogen atmosphere. A preliminary mixture is formed from 30.66 g of tert-butyl peroxy-2-ethylhexanoate, 78.93 g of isobornyl methacrylate, 157.85 g of n-butyl acrylate, 91.08 g of glycerol monomethacrylate, 71.84 g of hydroxyethyl methacrylate, 11.84 g of methacrylic acid and 7.38 g of mercaptoethanol; this monomer mixture is added to the liquid phase over 4 hours. Following complete addition of the monomer, stirring is carried out for 30 minutes more and then the batch is cooled to 80° C. 0.42 g of tert-butyl peroxy-2-ethylhexanoate in solution in 10.0 g of n-butyl acetate is added and the batch is stirred at 80° C. for 2 hours. A further 40 g of n-butyl acetate are added, and stirring is carried out for 30 minutes without further heating.

### Varnish Production

Films having a thickness of 30+/−5 μm were produced.

### Curing Conditions:

25 min at 145° C. in a forced-air drying oven

### Viscosities

The viscosities of the resins obtained are below 20 000 mPas at 23° C. The results are compiled in Table 1.

TABLE 1
Viscosities

| | Brookfield, 23° C., | DIN4 flow cup, 23° C., |
|---|---|---|
| | polymer content: 75% | polymer content: 55% |
| 0 mol % GMMA | 5180 mPas | 29.9 s |
| 10 mol % GMMA | 10 000 mPas | 43.9 s |
| 20 mol % GMMA | 18 500 mPas | 70.4 s |

### Investigation of Media Resistance

The crosslinked polymer films are treated with the various media for 15 minutes. This is done by pressing a soaked cotton cloth onto the surface. After drying has been carried out (24 hours at 23° C.) a measurement is made of the pendulum hardness (König pendulum hardness, DIN EN ISO 1522). The results are compiled in Table 2.

TABLE 2
Media resistance

| | molar ratio | | molar ratio | | molar ratio | |
|---|---|---|---|---|---|---|
| | GMMA/ | | GMMA/ | | GMMA/ | |
| | HEMA = 0/1 | | HEMA = 1/3 | | HEMA = 1/1 | |
| | wt. % | mol % | wt. % | mol % | wt. % | mol % |
| IBMA | 20.0 | 12.5 | 19.6 | 12.5 | 19.2 | 12.5 |
| nBA | 40.0 | 43.3 | 39.2 | 43.3 | 38.6 | 43.3 |
| GMMA | 0.0 | 0.0 | 11.3 | 10.0 | 22.1 | 20.0 |
| HEMA | 37.0 | 39.4 | 27.0 | 29.4 | 17.5 | 19.4 |
| GMAA | 3.0 | 4.8 | 2.9 | 4.8 | 2.9 | 4.8 |

| | | | |
|---|---|---|---|
| untreated | 191 s | 195 s | 191 s |
| Brake fluid | 101 s | 168 s | 175 s |
| Diesel | 104 s | 189 s | 182 s |
| 2-propanol | 55 s | 92 s | 181 s |
| MEK | 77 s | 120 s | 161 s |

IBMA: isobornyl methacrylate;
nBA: n-butyl acrylate;
GMMA: glycerol monomethacrylate;
HEMA: hydroxyethyl methacrylate;
GMAA: methacrylic acid;
MEK: methyl ethyl ketone

A high pendulum hardness value represents a high hardness in the resulting varnish film. The samples with glycerol monomethacrylate exhibit a substantially improved media resistance as compared to the polymer film containing no GMMA. The molar ratio GMMA/HEMA=1/1 shows the best properties.

1. A composition prepared by free-radically copolymerizing glycerol mono(meth)acrylate and hydroxyethyl methacrylate; and subsequently
crosslinking the copolymer material obtained with isocyanates.

2. The composition according to claim 1, wherein, in the step of copolymerization, the glycerol mono(meth)acrylate and hydroxyethyl methacrylate are free-radically polymerized in the presence of additional of additional monomers.

3. The composition according to claim 1, wherein glycerol mono(meth)acrylate and hydroxyethyl methacrylate are polymerized in a 1:1 molar ratio.

4. The composition according to claim 1, wherein the isocyanates are difunctional and/or polyfunctional aliphatic and aromatic isocyanates.

5. A process for preparing compositions according to claim 1, comprising:
copolymerizing glycerol mono(meth)acrylate, hydroxyethyl methacrylate and additional comonomers in a solvent at a temperature in the range of 100-150° C. and in the presence of initiator and are subsequently crosslinked with isocyanates in the presence of a catalyst.

6. The process according to claim 5, wherein said catalyst is an organotin compound are used for catalysis and a ratio of the isocyanate groups to OH groups in the copolymeric material (NCO/OH ratio) is set at 42/58, this ratio based on the OH number of the resin.

7. A method of forming a polymeric composition composed of glycerol mono(meth)acrylate and hydroxyethyl methacrylate, and optional additional comonomers, and then curing the copolymer via the isocyanate groups in film-forming resins.

8. The method according to claim 7, wherein the resin film is a media-resistant film.
